(19) United States
(12) Patent Application Publication
(10) Pub. No.: US 2026/0054529 A1
(43) Pub. Date: Feb. 26, 2026

(54) METHOD FOR DETERMINING A COMPENSATED DYNAMIC RADIUS OF A WHEEL OF A VEHICLE, METHOD FOR ESTIMATING THE DEPTH OF A TYRE TREAD, AND MOTOR VEHICLE FOR IMPLEMENTING SAID METHODS

(71) Applicant: CONTINENTAL AUTOMOTIVE TECHNOLOGIES GMBH, Hannover (DE)

(72) Inventors: Nicolas GUINART, Toulouse (FR); Andrei-Stefan CIMPONERIU, Giroc, Timis (RO); Guilhem PYRONNET, Toulouse (FR)

(73) Assignee: CONTINENTAL AUTOMOTIVE TECHNOLOGIES GMBH, Hannover (DE)

(21) Appl. No.: 19/103,704

(22) PCT Filed: Aug. 18, 2023
(86) PCT No.: PCT/EP2023/072850

§ 371 Date: Feb. 13, 2025

(30) Foreign Application Priority Data
Sep. 15, 2022 (FR) FR2209277

(51) Int. Cl. B60C 11/24; G01B 5/00; G01B 5/10; G01M 17/02

(52) U.S. Cl. CPC B60C 11/246; G01B 5/0025; G01B 5/10; G01M 17/02

(57) ABSTRACT

A method for determining a compensated dynamic radius of a wheel of a vehicle, the compensated dynamic radius being a function of: a raw dynamic radius, instantaneous values of variables, compensation factors specific to the variables. The compensation factors are obtained by a learning phase that includes: acquiring, when the vehicle is in operation and for each variable, values of the raw dynamic radius as a function of the evolution of the variables, calculating the compensation factors based on each of the values. Also disclosed is a method for estimating the depth of a tread of a tire and to a motor vehicle implementing the methods.

### CROSS REFERENCE TO RELATED APPLICATIONS

This application is the U.S. National Phase Application of PCT International Application No. PCT/EP2023/072850, filed Aug. 18, 2023, which claims priority to French Patent Application No. 2209277, filed Sep. 15, 2022, the contents of such applications being incorporated by reference herein.

### DESCRIPTION

### Field of the Invention

The field of the present invention is that of tires for wheels of a motor vehicle.

More specifically, the invention relates to a method for determining a compensated dynamic radius of a wheel of a vehicle, to a method for estimating the depth of a tread of a tire, and to a motor vehicle for implementing said methods.

### Background of the Invention

Conventionally, a tire comprises, on its outer surface, a zone referred to as the “tread”, corresponding to the outer surface of the tire that is in contact with the roadway.

The tread comprises a relief, also called the “tread pattern”, making it possible in particular to remove rainwater, snow, dust, heat, in order to limit loss of grip of the tire or prevent aquaplaning.

Over the course of the kilometers traveled by the vehicle, the tread of the tire wears and becomes smooth, thereby increasing the risk of loss of grip. Beyond a certain wear, it is therefore necessary to replace the worn tire with a new tire.

In order to detect the wear of a tire, it is known to use wear indicators in the form of a colored label integrated into the tread. As the tread comes into contact with the roadway, the tire wears and its thickness decreases until the tire wear indicator is exposed.

This solution is not particularly satisfactory in that the owner of the vehicle has to visually inspect their tire in order to determine whether it should be replaced. They must also remember to inspect their tires themselves. However, a person with average attention does not systematically inspect their tires and after a certain amount of time, there is a risk that they will travel in a vehicle fitted with worn tires offering only little grip, this posing an obvious hazard.

There is therefore a growing need for autonomous monitoring of the wear of a tire, in particular in the context of vehicle fleet management, which model forms part of the growing development of new modes of mobility in which the driver is not the owner and in which monitoring and maintenance are carried out by specific organizations on large groups of vehicles.

Autonomous monitoring of the wear of a tire therefore applies to an even greater extent to autonomous vehicles.

In order to overcome these drawbacks, it is known to monitor the wear state of the tread of the tire based on the dynamic radius of the wheel.

Reference is made to FIG. 1 to define what a dynamic radius is understood to mean.

A tire 1, mounted on a vehicle wheel (the vehicle and the wheel not being shown), rests on the ground 3. The laden tire 1 is deformed in the zone of contact between the tire 1 and the ground 3, via its tread. In this zone of contact, the radius of the tire 1 is defined by the laden radius R_{c}, which corresponds to the distance between the axis of rotation 5 of the wheel and the ground 3.

The laden radius R_{c} is less than the nominal radius Rₙ, defined by the radius of the tire when the wheel is not laden, that is to say when it is not mounted in the vehicle.

It will therefore be understood that the distance traveled by the tire 1 differs depending on whether the nominal radius or the laden radius is considered. The length developed by the laden radius R_{c} over one wheel revolution is thus less than that obtained by the nominal radius Rₙ.

The purpose of determining the dynamic radius is to give a radius value as close as possible to the actual distance traveled by the tire 1.

More precisely, the dynamic radius R_{dyn} of a wheel is the radius of the virtual wheel that would be in point contact with the ground, with the same linear speed and the same rotational speed as the real wheel.

The prior art has identified numerous physical variables that influence the value of the dynamic radius. Among these variables, in particular pressure, speed, squared speed and load are selected.

The way in which these variables influence the value of the dynamic radius depends on what are known as “compensation” parameters, which are representative of the wear state of the tire and which thus evolve over time.

Document EP2867036B1, incorporated by reference, discloses one solution aimed at quantifying the instantaneous dynamic radius taking into partial account the wear state of the tire.

To this end, the method proposes to measure, in a first stage, what is referred to as a “raw” dynamic radius equal to the speed of the vehicle divided by the rotational speed of the wheel, and then to compensate for this dynamic radius measurement as a function of the current variables (that is to say those measured at a given time) selected as influencing the value of the dynamic radius (in particular pressure, speed, squared speed, load).

This then gives rise to what is referred to as a “compensated” dynamic radius, which is a function of the raw dynamic radius and of the current variables.

The method described in that document also proposes to integrate compensation parameters representative of the wear state of a tire into the calculation of the dynamic radius.

These parameters are learnt through specific preliminary tests carried out in the factory and then integrated into the dynamic radius calculation algorithm in the form of charts giving values of compensation parameters to be applied for a type of tire under consideration. Document US2017363515A1, incorporated by reference, also describes a method for monitoring the wear of a tire, which also proposes to record such compensation parameters in a table.

One drawback of that solution is that the compensation parameters applied in the calculation algorithm are applied systematically regardless of the tire of a family under consideration, and independently of changes that may occur during the life of the tire.

Prior-art document WO2021247036A1, incorporated by reference, is also known and describes a system using a tire monitoring sensor to determine data regarding dimension, pressure, identification, load parameters, deformation, etc. as a function of the current circumference of the tire. After having determined these parameters, an algorithm determines the wear value for the tires. A controller adjusts the parameters of the tire, such as the radius of the tire, on the basis of various variables such as temperature, stiffness, acceleration, load, etc.

Like in the case of document EP2867036B1, the system and the method described in document WO2021247036A1 do not make it possible to take into account the behavior of the tire when it is used on a vehicle, that is to say during the life of the tire on the vehicle.

Document US2021188017A1, incorporated by reference, is also known and describes a system and a method for monitoring tread wear by measuring various parameters such as tread depth, tire acceleration, inflation pressure, loads associated with the tires, etc. The system determines a calibrated tire wear model on the basis of the measured tire parameters. This system operates using an electronic control unit or a cloud computing system installed on the vehicle to run the system.

However, like in the case of documents EP2867036B1 and WO2021247036A1, the system and the method described in document US2021188017A1 propose to carry out characterization before the tire is used in a vehicle, and to do so for each type of tire.

The systems and method in document US2021188017A1 thus also do not make it possible to take into account evolutions in the behavior of the tire when it is used on a vehicle.

### SUMMARY OF THE INVENTION

An aspect of the present invention aims to overcome the drawbacks of the prior art, and to this end relates to a method for determining a compensated dynamic radius of a wheel of a vehicle, said wheel comprising a tire and said vehicle comprising a set of sensors able to acquire signals representative of variables chosen from a group comprising at least: the speed of the vehicle, the rotational speed of said wheel, the pressure of said tire, the load of said wheel, said compensated dynamic radius being a function of:
a raw dynamic radius, calculated based on the instantaneous speed of said vehicle and the instantaneous rotational speed of said wheel,
instantaneous values of the variables under consideration,
reference values of the variables under consideration, said method being noteworthy in that the compensated dynamic radius is also a function of compensation factors that are specific to said variables under consideration and obtained by executing a learning phase, which comprises:
acquiring, when said vehicle is in operation and for each of said variables, sets of values of the raw dynamic radius as a function of the evolution of said variables,
calculating said compensation factors based on each of said sets of acquired values.

Therefore, in contrast to the prior art, in which compensation factors were learnt through specific preliminary tests carried out in the factory, an aspect of the present invention makes provision to acquire on-line, that is to say during the life of the tire mounted on the vehicle during operation, sets of values of the raw dynamic radius as a function of the evolution of the variables identified as influencing the value of the dynamic radius.

On the basis of these sets of acquired values, the compensation factors specific to each variable are calculated.

The compensation factors are thus updated throughout the life of the tire.

Integrating these updated compensation factors into the compensated dynamic radius calculation algorithm makes it possible to take into account changes in behavior that occur during the life of the tire, and to do so regardless of the type of tire.

According to some optional features of the method according to an aspect of the invention:
in a first implementation, the learning phase is executed continuously;
in a second implementation, the acquisition step is performed over a finite period;
the learning phase is initiated following a step of detecting one or more predefined trigger events;
the trigger events are chosen from a group comprising at least: a change of location of the wheel, a change of wheel or tire on the same axle, detection of a change of vehicle driving habit, aging of the tires, overload situation detected when a predetermined overload threshold has been exceeded over a predetermined period, overspeed situation detected when a predetermined overspeed threshold has been exceeded over a predetermined period, predetermined minimum or maximum pressure threshold value reached by a tire, expiry of a predetermined period of use;
the method comprises a monitoring phase initiated when no trigger event has been detected beforehand and which comprises acquiring, when said vehicle is in operation, over a finite period and for each of said variables, sets of values of the raw dynamic radius as a function of the evolution of said variables;
according to one provision, the monitoring phase follows the learning phase and the compensation factors acquired in said learning phase are used to determine the compensated dynamic radius;
according to one provision, the step that comprises calculating the compensation factors based on each of the sets of acquired values is obtained by applying a multi-linear regression to each of said sets of acquired values;
in one implementation, the learning phase comprises, prior to the step of executing the multi-linear regression, a step of severe filtering, applied to the sets of acquired values of the raw dynamic radius;
in one implementation, the monitoring phase comprises a step of “low severity” to “medium severity” filtering, applied to the sets of acquired values of the raw dynamic radius.

An aspect of the invention also relates to a method for estimating the depth of a tread of a tire, noteworthy in that the depth of said tread is estimated based on a temporal variation of the compensated dynamic radius determined according to an aspect of the invention.

An aspect of the invention also relates to a motor vehicle comprising hardware and/or software means for implementing the methods according to an aspect of the invention.

### BRIEF DESCRIPTION OF THE DRAWINGS

Other features, aims and advantages of aspects of the invention will become apparent upon reading the following detailed description, for the understanding of which reference will be made to the appended drawings, in which:

FIG. 1 is a schematic view of a tire of a vehicle wheel.

FIG. 2 details the steps of the method for determining a compensated dynamic radius of a wheel of a vehicle according to an aspect of the invention.

FIG. 3 is a graph showing dynamic radius values acquired as a function of measured pressure for one of the tires of the vehicle.

FIG. 4 is a graph showing dynamic radius values acquired as a function of measured vehicle speed for one of the tires of the vehicle.

FIG. 5 is a graph showing dynamic radius values acquired as a function of measured pressure and speed for one of the tires of the vehicle.

FIG. 6 is a graph showing one example of linear regression applied to the dynamic radius values acquired as a function of the measured pressure values.

FIG. 7 is a flowchart showing one example of an algorithm able to be implemented to execute the method for determining a compensated dynamic radius of a wheel of a vehicle according to an aspect of the invention.

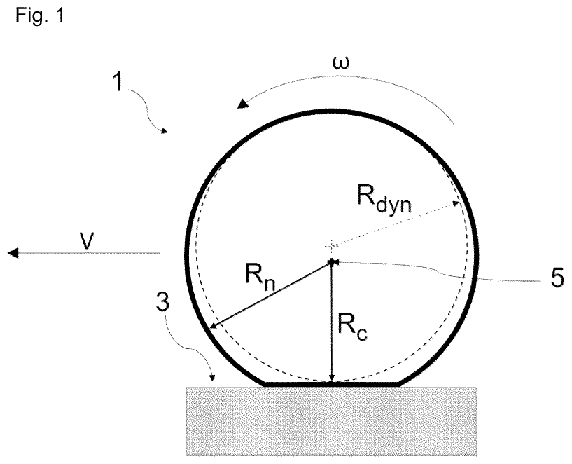

### DETAILED DESCRIPTION OF EXEMPLARY EMBODIMENTS

In the remainder of the description, elements that have an identical structure or similar functions are denoted by one and the same reference.

The method for determining a compensated dynamic radius of a wheel of a vehicle according to an aspect of the invention is implemented in a vehicle (not shown in the figures) equipped with hardware and software means suitable for implementing said method.

To this end, the software means comprise a computer program code means comprising in particular the algorithm implemented to execute the method of an aspect of the invention.

The hardware means, for their part, comprise a set of dedicated sensors able to acquire signals representative of physical variables identified as influencing the value of the dynamic radius.

These variables are chosen from a group comprising at least: the speed of the vehicle, the rotational speed of said wheel, the pressure of said tire, the load of said wheel.

As is known, the speed of the vehicle may be acquired by a global positioning system (GPS). The rotational speed of the wheel may be provided by a wheel speed sensor (WSS). The pressure is provided by a tire pressure monitoring system (TPMS). The load may be provided by carrying out calculations on data from the TPMS.

Other variables may also be monitored using sensors known to those skilled in the art, such as temperature, squared speed, wheel torque, quotient of footprint of the wheel on the ground.

According to an aspect of the invention, the compensated dynamic radius of the wheel is a function of:
the raw dynamic radius, calculated based on the instantaneous speed of said vehicle and the instantaneous rotational speed of said wheel,
instantaneous values of the variables under consideration,
reference values of the variables under consideration, and
compensation factors specific to the variables under consideration, updated throughout the life of the tire.

To this end, the method that forms the subject of an aspect of the invention makes provision to obtain the compensation factors by executing learning phases that are initiated throughout the life of the tire.

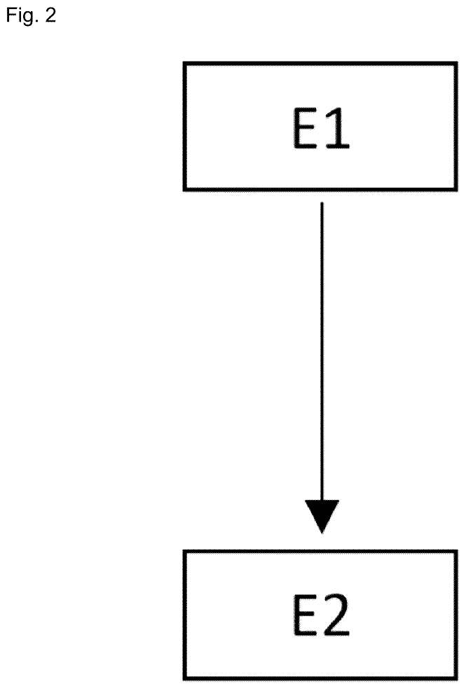

FIG. 2 details the steps of a learning phase of the method of an aspect of the invention.

The learning phase comprises a first step E1 of acquiring signals, followed by a second step E2 of calculating the compensation factors based on the acquired signals.

Signal acquisition step E1 aims to acquire, when said vehicle is in operation and for each variable identified as influencing the value of the dynamic radius, sets of values of the raw dynamic radius as a function of the evolution of these variables.

For example, when the monitored variables are vehicle speed, wheel rotational speed, wheel tire pressure and wheel load, the evolution of the dynamic radius as a function of each of these variables is monitored.

Thus, using the set of sensors described above, values of the dynamic radius are acquired as a function of the pressure values measured for each tire over a given period, values of the dynamic radius are acquired as a function of the vehicle speed values, for each wheel of the vehicle, and values of the dynamic radius are acquired as a function of the load values measured for each wheel.

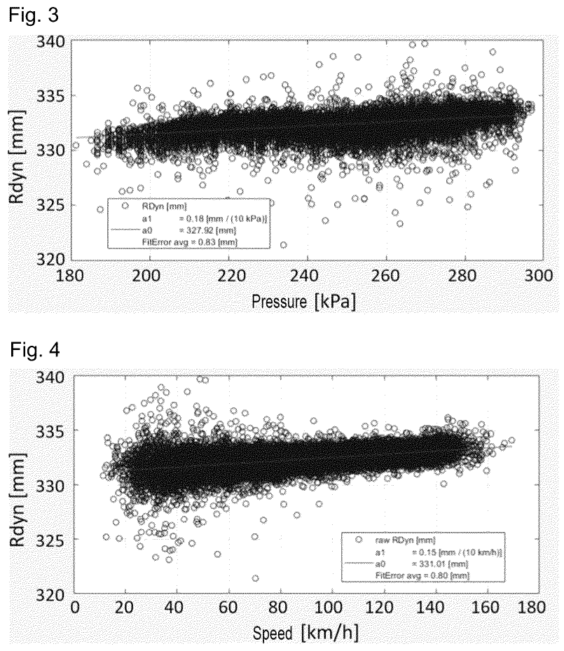

This thus gives rise to two-dimensional or three-dimensional point clouds, as illustrated in FIGS. 3 to 5.

As shown in FIG. 3, a two-dimensional point cloud is obtained, representing the values of the dynamic radius as a function of the pressure values measured over a given period. These values are acquired for all of the tires of the vehicle (the values in relation to a single tire are illustrated in FIG. 3).

As shown in FIG. 4, a two-dimensional point cloud is obtained, representing the values of the dynamic radius as a function of the vehicle speed values over a given period. These values are acquired for all of the tires of the vehicle (the values in relation to a single tire are illustrated in FIG. 4).

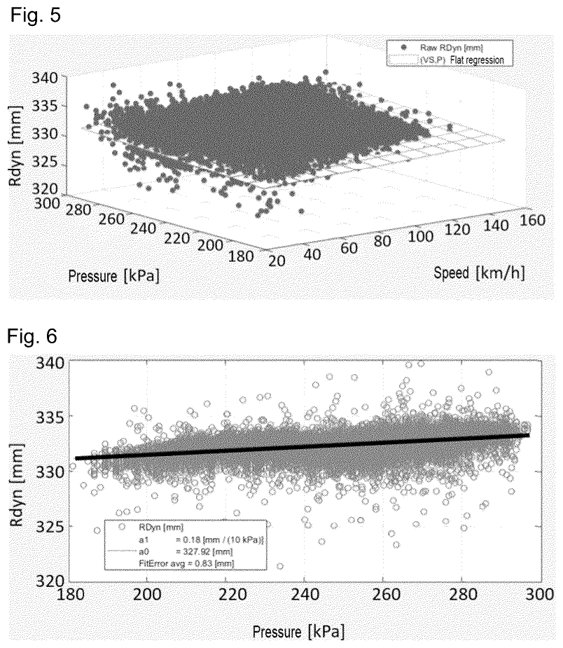

As shown in FIG. 5, a three-dimensional point cloud is obtained, representing the values of the dynamic radius as a function of the pressure values measured over a given period and as a function of the vehicle speed values over a given period. These values are acquired for all of the tires of the vehicle (the values in relation to a single tire are illustrated in FIG. 5).

When the values have been acquired, step E2 is initiated, which comprises calculating the compensation factors specific to each variable based on each of the sets of acquired values.

This calculation step is executed by way of mathematical functions comprising in particular a multi-linear regression, applied to each set of acquired values.

For reasons of limiting memory resources, the algorithm that determines the value of the compensation factor for the variable under consideration (step E2) is recursive, this meaning that the calculation is updated after each new measurement.

More specifically, step E2 is an iteration providing an intermediate update of the compensation factor under consideration. Step E2 is applied as many times as necessary until end-of-learning conditions are reached. The value of the compensation factor from the last iteration then becomes the value selected for calculating the compensated dynamic radius.

FIG. 6 shows the straight line obtained by linear regression applied to the values of the dynamic radius for one of the tires of the vehicle, as a function of the measured pressure values.

Here, the slope of the straight line is equal to 0.18 mm/10 kPa, this meaning that, if the pressure of a tire has increased by 10 kPa (0.1 bar), the dynamic radius increases by 0.18 mm.

The compensation factor selected for the pressure and for the tire under consideration is then equal to 0.18 mm/10 kPa.

The same procedure is followed for all of the tires of the vehicle and for all of the monitored variables.

The compensated dynamic radius is then calculated using the following formula:

$${R}_{{dyn}_{comp}} = {R}_{{dyn}_{raw}} + \sum ( {α}_{{i}_{comp}} * ( {K}_{i} - {K}_{{i}_{ref}} ) )$$

Where:
R_{dyn}_{_{comp}} is the compensated dynamic radius of the wheel,
R_{dyn}_{_{raw}} is a raw dynamic radius of the wheel, defined by the following formula:

$${R}_{{dyn}_{raw}} = \frac{{V}_{vehicle}}{ω} ,$$

where V_{vehicle} is the instantaneous speed of the vehicle and ω is the instantaneous rotational speed of said wheel,
where aᵢ_{_{comp}} is the compensation factor specific to the variable i under consideration,
where Kᵢ is an instantaneous value of the variable i under consideration,
where Kᵢ_{_{ref}} is a reference value of the variable i under consideration.

Thus, when the monitored variables are vehicle speed, wheel rotational speed, wheel tire pressure and wheel load, the compensated dynamic radius is calculated using the following formula:

$${R}_{{dyn}_{comp}} = \frac{V}{ω} + {V}_{comp} * ( V - {V}_{ref} ) + {P}_{comp} * ( P - {P}_{ref} ) + {L}_{comp} * ( L - {L}_{ref} )$$

where:
R_{dyn}_{_{comp}} is the compensated dynamic radius of the wheel,
V is the instantaneous speed of the vehicle,
ω is the instantaneous rotational speed of said wheel,
V_{comp} is the vehicle speed compensation parameter,
V_{ref} is a vehicle speed reference value,
P is the instantaneous wheel tire pressure,
P_{comp} is the wheel tire pressure compensation parameter,
P_{ref} is a wheel tire reference value,
L is the instantaneous load of the wheel,
L_{comp} is the wheel load compensation parameter,
L_{ref} is a wheel load reference value.

According to one provision of an aspect of the invention, the step of calculating the compensation factors in the learning phase may be supplemented by a filtering step that is initiated prior to the step of executing the multi-linear regression.

The type of filtering may be what is referred to as “severe” filtering, and is applied to the sets of raw dynamic radius values acquired as a function of the variables under consideration, in order to guarantee that learning is conducted with input signals that are as clean as possible.

The filtering is obtained using a statistical criterion related to the mean standard deviation of the dynamic radius. To this end, a choice is made to reject an instantaneous value of the dynamic radius when this value deviates by a predetermined value that is a function of this standard deviation.

For example, if the current value of the dynamic radius is higher than the absolute value of three times the standard deviation, it is then rejected.

By way of example, test results show that the standard deviation for “severe” filtering is equal to 0.5 millimeters. Thus, what is referred to as “severe” filtering rejects dynamic radius values that deviate by +/−1.5 millimeters from the current mean.

According to one execution of the method of an aspect of the invention, the acquisition step (step E1) may be executed over a finite period.

According to one provision of an aspect of the invention, the learning phase may be initiated following detection of trigger events.

By way of non-limiting examples, these trigger events are chosen in particular from a group comprising at least:
a change of location of the wheel,
a change of wheel or tire on the same axle,
detection of a change of vehicle driving habit, such as for example detection of a change of average speed due to a change of ownership of the vehicle; change of vehicle driving habit is a datum that is able to be determined by various technical means related to the operation of the vehicle,
aging of the tires,
overload situation able to be detected when a predetermined overload threshold has been exceeded over a predetermined period,
overspeed situation able to be detected when a predetermined overspeed threshold has been exceeded over a predetermined period,
predetermined minimum or maximum pressure threshold value reached by a tire,
expiry of a predetermined period of use.

According to one provision of an aspect of the invention, when no trigger event has been detected, what is initiated is not a learning phase, but rather what is referred to as a monitoring phase.

This monitoring phase comprises acquiring sets of values of the raw dynamic radius as a function of the evolution of the selected variables, but not calculating the compensation factors.

The compensation factors used to calculate the compensated dynamic radius are then those acquired and stored in memory in the learning phase. The monitoring phase therefore preferably comes after the learning phase.

In the event that the monitoring phase does not come after the learning phase and the compensation factors have not yet been calculated, it is possible to use compensation factors supplied by the manufacturer for a type of tire under consideration.

When a monitoring phase is being performed, filtering that is not as severe as that applied for the learning phase is applied to the sets of acquired values of the raw dynamic radius. This is filtering referred to as “low severity” to “medium severity”. Like for the “severe” filtering, the “low severity” to “medium severity” filtering is applied using a statistical criterion related to the mean standard deviation of the dynamic radius, rejecting an instantaneous value of the dynamic radius when this value deviates by a predetermined value that is a function of this standard deviation.

If the current value of the dynamic radius is higher than the absolute value of three times the standard deviation, it is then rejected. By way of example, test results show that the standard deviation for “low severity” to “medium severity” filtering is equal to 1 millimeter.

Thus, what is referred to as “low severity” to “medium severity” filtering rejects dynamic radius values that deviate by +/−3 millimeters from the current mean.

According to one execution variant of the method of an aspect of the invention, the acquisition step (step E1) may be executed continuously. In this embodiment, there is no longer any need for a trigger element in order to initiate the learning phase. The learning is therefore continuous, this meaning that there is no distinction between the learning phase and the monitoring phase. Thus, the compensation parameters are updated in each iteration and are directly taken into consideration in calculating the compensated dynamic radius.

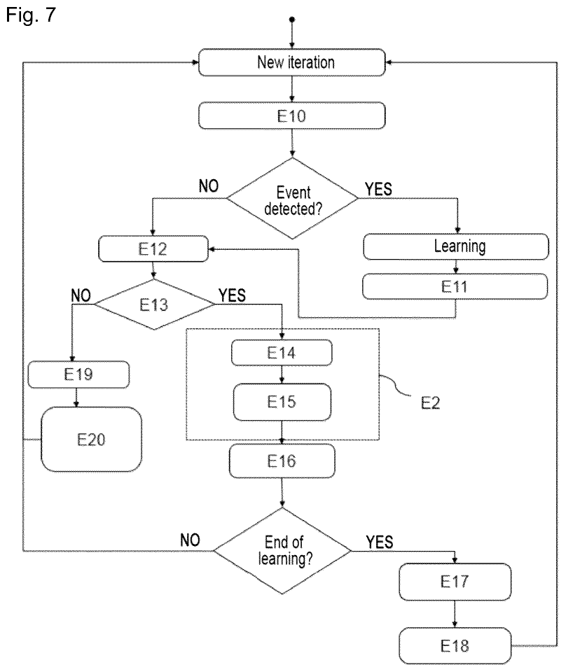

Reference is made to FIG. 7, which shows a flowchart that describes one example of an algorithm that may be implemented to execute the method for determining a compensated dynamic radius of a wheel of a vehicle according to an aspect of the invention.

The algorithm loops through successive iterations. When the cycle reaches a new iteration, the events that may have occurred since the last iteration are evaluated (step E10).

If a trigger event has occurred, then a transition takes place to a learning phase.

All of the compensation factors previously calculated are then reset, that is to say all of the compensation factors acquired beforehand are erased (E11).

Step E12 comprises acquiring, using the dedicated sensors, signals representative of physical variables identified as influencing the value of the dynamic radius (corresponding to step E1 described above).

The question is again asked as to whether the algorithm is still in the learning phase (step E13). A priori, if an event that triggered a learning phase has been detected beforehand, then the probability that the method is still in the learning phase is high.

If the answer is yes, then the step comprising calculating the compensation factors is initiated (step E2 of the method of an aspect of the invention).

Severe filtering may be applied to the sets of values of the raw dynamic radius acquired as a function of the variables under consideration (step E14).

The multi-linear regression is then applied to the values of the dynamic radius acquired as a function of the variables under consideration, so as to deduce the compensation factors therefrom (step E15).

The algorithm then asks the question as to whether end-of-learning conditions have been reached (step E16).

If the answer is no, it loops back to the initial step and a new iteration of the algorithm is initiated without storing the calculated compensation factors in memory.

If the answer is yes, the compensation factors are stored in memory (step E17) and a transition takes place to a monitoring phase (step E18).

The algorithm then loops back to the initial step and a new iteration is initiated using the acquired compensation factors stored in memory in step E17.

If no trigger event is detected (step E10), this most likely being the case given that an end-of-learning step was detected beforehand, a transition takes place to signal acquisition step E12, which comprises acquiring signals representative of physical variables identified as influencing the value of the dynamic radius. The compensation factors used to calculate the compensated dynamic radius are then those acquired and stored in memory in the learning phase.

The question is again asked as to whether the algorithm is in the learning phase (step E13), and the answer will most likely be negative.

“Low severity” to “medium severity” filtering may be applied to the sets of values of the raw dynamic radius acquired as a function of the variables under consideration (step E19).

A transition then takes place to step E20, which comprises applying the compensation factors stored in memory in the learning phase in order to calculate the compensated dynamic radius.

According to one particular application of the method of an aspect of the invention, the temporal variation of the compensated dynamic radius measured by the method that has just been described is used in order to estimate the depth of the tread of a tire.

Indeed, if temporal variations of the compensated dynamic radius are observed when the raw dynamic radius has already been compensated for by the compensation factors applied to the monitored variables, then the variations of the compensated dynamic radius reflect a variation in the depth of the tread of the tire.

The vehicle (not shown in the figures) comprises hardware and/or software means for implementing the method according to an aspect of the invention for estimating the depth of a tread of a tire that forms the subject of an aspect of the invention. The software means may in particular comprise a computer program code means, comprising in particular the algorithm designed to carry out the steps of the method for estimating the depth of a tread of a tire.

It should be noted that determining the compensated dynamic radius may have benefits other than that of estimating the depth of a tread of a tire, such as in particular that of making it possible to estimate the longitudinal speed of the vehicle or else that of an application related to odometry, that is to say the precise estimation of distance traveled.

Of course, the present invention is not limited solely to the embodiments of this method for determining a compensated dynamic radius of a wheel of a vehicle, of this method for estimating the depth of a tread of a tire and of this vehicle for implementing said methods, which are described above purely by way of illustrative example, but rather it encompasses all variants involving technical equivalents of the means.

1. A method for determining a compensated dynamic radius of a wheel of a vehicle, said wheel comprising a tire and said vehicle comprising a set of sensors able to acquire signals representative of variables chosen from a group comprising at least: the speed of the vehicle, the rotational speed of said wheel, the pressure of said tire, the load of said wheel,
said compensated dynamic radius being a function of:
a raw dynamic radius, calculated based on the instantaneous speed of said vehicle and the instantaneous rotational speed of said wheel,
instantaneous values of the variables under consideration,
reference values of the variables under consideration,
therein in said method the compensated dynamic radius is also a function of compensation factors that are specific to said variables under consideration and obtained by executing a learning phase, which comprises:
acquiring, when said vehicle is in operation and for each of said variables, sets of values of the raw dynamic radius as a function of the evolution of said variables,
calculating said compensation factors based on each of said sets of acquired values.

2. The method as claimed in claim 1, wherein the learning phase is executed continuously.

3. The method as claimed in claim 1, wherein the acquisition step is performed over a finite period.

4. The method as claimed in claim 2, wherein the learning phase is initiated following a step of detecting one or more predefined trigger events.

5. The learning method as claimed in claim 4, wherein the trigger events are chosen from a group comprising at least:
a change of location of the wheel,
a change of wheel or tire on the same axle,
detection of a change of vehicle driving habit,
aging of the tires,
overload situation detected when a predetermined overload threshold has been exceeded over a predetermined period,
overspeed situation detected when a predetermined overspeed threshold has been exceeded over a predetermined period,
predetermined minimum or maximum pressure threshold value reached by a tire,
expiry of a predetermined period of use.

6. The method as claimed in claim 4, further comprising a monitoring phase initiated when no trigger event has been detected beforehand and which comprises acquiring, when said vehicle is in operation, over a finite period and for each of said variables, sets of values of the raw dynamic radius as a function of the evolution of said variables.

7. The method as claimed in claim 6, wherein the monitoring phase follows the learning phase and in that the compensation factors acquired in said learning phase are used to determine the compensated dynamic radius.

8. The method as claimed in claim 1, wherein the step that comprises calculating the compensation factors based on each of the sets of acquired values is obtained by applying a multi-linear regression to each of said sets of acquired values.

9. The method as claimed in claim 8, wherein the learning phase comprises, prior to the step of executing the multi-linear regression, a step of “severe” filtering, applied to the sets of acquired values of the raw dynamic radius.

10. The method as claimed in claim 6, wherein the monitoring phase comprises a step of “low severity” to “medium severity” filtering, applied to the sets of acquired values of the raw dynamic radius.

11. A method for estimating the depth of a tread of a tire, wherein the depth of said tread is estimated based on a temporal variation of the compensated dynamic radius determined as claimed claim 1.

12. A motor vehicle, comprising hardware and/or software for implementing the method as claimed claim 1.
